(19) United States
(12) Patent Application Publication
(10) Pub. No.: US 2023/0243154 A1
(43) Pub. Date: Aug. 3, 2023

(54) REINFORCING BAR COUPLER

(71) Applicant: Eun Kwan KI, Gyeongsangnam-do (KR)

(72) Inventor: Eun Kwan KI, Gyeongsangnam-do (KR)

(21) Appl. No.: 17/918,739

(22) PCT Filed: Apr. 1, 2021
(86) PCT No.: PCT/KR2021/004046

§ 371 Date: Oct. 13, 2022

(30) Foreign Application Priority Data
Apr. 13, 2020 (KR) 10-2020-0044669

(51) Int. Cl. E04C 5/16; F16B 7/18

(52) U.S. Cl. CPC E04C 5/165; F16B 7/182

(57) ABSTRACT

A reinforcing bar coupler according to the present invention comprises a first coupler and a second coupler, which are integrally coupled by friction welding while the end portions of a pair of reinforcing bars are accommodated therein, and which are confined in contact with each other by means of screw coupling so that the pair of reinforcing bars are connected on a straight line, wherein each of the first coupler and the second coupler has, on one side thereof, an accommodation space that is recessed so as to accommodate one end portion of the reinforcing bar, and a catching groove, which has the largest inner diameter inside the accommodation space so as to accommodate molten metal formed by dissolving a part of the first coupler, the second coupler and the reinforcing bars, and which catches and restrains the solidified molten metal so as to prevent same from flowing out in the longitudinal direction of the reinforcing bar.

### TECHNICAL FIELD

The present invention relates to a reinforcing bar coupler, and more particularly, to a reinforcing bar coupler configured such that a first coupler and a second coupler are joined to ends of reinforcing bars by friction welding, respectively, and the first coupler and the second coupler are connected to each other by screw-coupling, so that connection work is improved.

The present invention relates to a reinforcing bar coupler in which accommodation spaces for accommodating parts of the reinforcing bars are provided inside the first coupler and the second coupler, so that durability against bending stress is improved.

The present invention relates to a reinforcing bar coupler having a melting part with an outer diameter smaller than an outer diameter of the reinforcing bar inside the accommodation space so as to be melted before the reinforcing bar during friction welding, so that bonding strength may be improved.

The present invention relates to a reinforcing bar coupler in which a catching groove is formed inside the accommodation space to accommodate the melted melting part, so that a reinforcing bar is restricted in a longitudinal direction when being cooled, and durability against reciprocating vibration is improved.

The present invention relates to a reinforcing bar coupler in which a filling wedge is provided inside the accommodation space to accommodate a melting part remaining after filled in a catching part, so that binding force to a reinforcing bar is improved.

### BACKGROUND ART

In general, deformed reinforcing bars having two rows of ribs symmetrically over the entire length in the longitudinal direction are mainly used as reinforcing bars used for a frame during constructing a reinforced concrete structure in order to improve a bond stress level with concrete. Because the reinforcing bars are produced in a limited length for transport or work convenience, most of the reinforcing bars are connected in use. Various types of schemes are used to connect the deformed reinforcing bars.

For example, as shown in FIG. 1, Korean Unexamined Patent No. 10-2003-32149 discloses a universal nut type reinforcing bar coupler, in which reinforcing bars 10 are formed at both ends thereof with male screws, shells 31 and 31′ are fastened to the male screws, respectively, and the shells 31 and 31′ are fitted and coupled to both sides of a cap coupling part 40 serving as a connecting member.

However, since the related art has a complex structure with various parts that are required to be assembled and connected, the convenience of connection work is significantly deteriorated.

Accordingly, as shown in FIG. 2, Korean Utility Model Registration No. 20-0457568 discloses a reinforcing bar connection structure characterized in that two bar-shaped reinforcing bars 2 are connected by a coupling part 4, in which the coupling part 4 includes a sleeve 6 welded to one end of the reinforcing bar 2 and formed with a female screw 8 and a male screw 10 welded to the other end of reinforcing bar 2, wherein the two reinforcing bars 2 are connected by fastening the male screw 10 to the female screw 8.

However, the related art is undesirable because the welded part is weak and damaged upon bending stress and causes an accident.

### DISCLOSURE

### Technical Problem

In order to solve the problems as mentioned above, an object of the present invention is to provide a reinforcing bar coupler, in which a first coupler and a second coupler are joined to ends of reinforcing bars by friction welding, respectively, and the first coupler and the second coupler are connected to each other by screw-coupling, so that connection work is improved.

Another object of the present invention is to provide a reinforcing bar coupler in which accommodation spaces for accommodating parts of the reinforcing bars are provided inside the first coupler and the second coupler, so that durability against bending stress is improved.

Still another object of the present invention is to provide a reinforcing bar coupler having a melting part with an outer diameter smaller than an outer diameter of the reinforcing bar inside the accommodation space so as to be melted before the reinforcing bar during friction welding, so that bonding strength is improved.

Still another object of the present invention is to provide a reinforcing bar coupler in which a catching groove is formed inside the accommodation space to accommodate the melted melting part, so that a reinforcing bar is restricted in a longitudinal direction when being cooled, and durability against reciprocating vibration is improved.

Still another object of the present invention is to provide a reinforcing bar coupler in which a filling wedge is provided inside the accommodation space to accommodate a melting part remaining after filled in a catching part, so that binding force to a reinforcing bar is improved.

### Technical Solution

The reinforcing bar coupler according to the present invention includes a first coupler and a second coupler, which are integrally coupled by friction welding while the end portions of a pair of reinforcing bars are accommodated therein, and which are confined in contact with each other by means of screw coupling so that the pair of reinforcing bars are connected on a straight line, wherein each of the first coupler and the second coupler has, on one side thereof, an accommodation space that is recessed so as to accommodate one end portion of the reinforcing bar, and a catching groove, which has the largest inner diameter inside the accommodation space so as to accommodate molten metal formed by dissolving a part of the first coupler, the second coupler and the reinforcing bars, and which catches and restrains the solidified molten metal so as to prevent same from flowing out in the longitudinal direction of the reinforcing bar.

A melting part, which protrudes to have an outer diameter smaller than an outer diameter of the reinforcing bar so as to be melted before the reinforcing bar during friction welding with the reinforcing bar, may be provided at one side inside the accommodation space.

The first coupler and the second coupler may be formed with any one of a connecting male screw and a connecting female screw screwed to each other so as to be positioned on a straight line, and may have the same shape at opposite portions in which the connecting male screw and the connecting female screw are not formed.

A vibration-prevention part, which is inclined such that the male and connecting female screws are in surface contact with each other upon screw-coupling together so as to restrict circumferential movements of the first coupler and the second coupler, may be provided at the ends of the connecting male screw and the connecting female screw.

A plurality of filling wedges may be provided on an inner circumferential surface of the accommodation space to accommodate molten metal remaining after filling the catching groove to increase the binding force to the reinforcing bar.

### Advantageous Effects

According to the reinforcing bar coupler of the present invention, the first coupler and the second coupler are joined to ends of the reinforcing bars by friction welding, and the first coupler and the second coupler are coupled to each other by screw-coupling. Accordingly, a pair of reinforcing bars can be easily connected to each other, so that workability can be improved.

In addition, according to the present invention, accommodation spaces for accommodating parts of the reinforcing bars are provided inside the first coupler and the second coupler, so that the durability against bending stress can be improved.

In addition, a melting part is provided to have an outer diameter smaller than an outer diameter of the reinforcing bar inside the accommodation space so as to be melted before the reinforcing bar during friction welding, so that the bonding strength between the first and second couplers and the reinforcing bars can be improved.

In addition, a catching groove is formed inside the accommodation space to accommodate the melted melting part, so that the reinforcing bar can be restricted in a longitudinal direction when being cooled, and the durability against reciprocating vibration can be improved.

In addition, a filling wedge is provided inside the accommodation space to accommodate a melting part remaining after filled in a catching part, so that the binding force to the reinforcing bar can be further improved.

### DESCRIPTION OF DRAWINGS

FIG. 1 is a partial incised perspective view showing a universal nut type reinforcing bar coupler disclosed in Korean Unexamined Patent No. 10-2003-32149.

FIG. 2 is an exploded perspective view showing a reinforcing bar connection structure disclosed in Korean Utility Model Registration No. 20-0457568.

FIG. 3 is a perspective view showing a using example of the reinforcing bar coupler according to the present invention.

FIG. 4 is a longitudinal sectional view showing an internal structure of the reinforcing bar coupler according to the present invention.

FIG. 5 is an exploded longitudinal sectional view showing a structure between the first and second couplers, which are the main components of the reinforcing bar coupler according to the present invention.

FIG. 6 is a longitudinal sectional view showing a state in which reinforcing bars are inserted into the first coupler and the second coupler, which are the main components of the reinforcing bar coupler according to the present invention.

FIG. 7 is a longitudinal sectional view showing a state in which the reinforcing bars are integrated with the first and second couplers, respectively, which are the main components of the reinforcing bar coupler according to the present invention.

FIG. 8 is a longitudinal sectional view showing a structure according to another embodiment in which filling wedges are applied inside accommodation spaces in the reinforcing bar coupler according to the present invention.

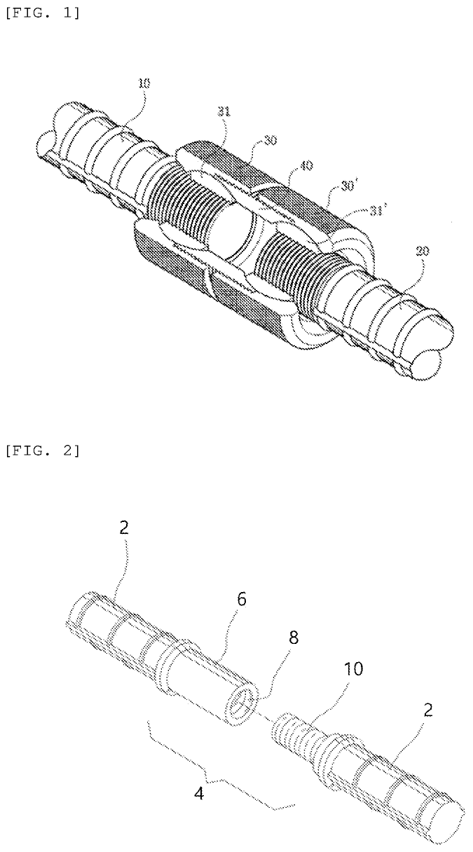

### BEST MODE

### Mode for Invention

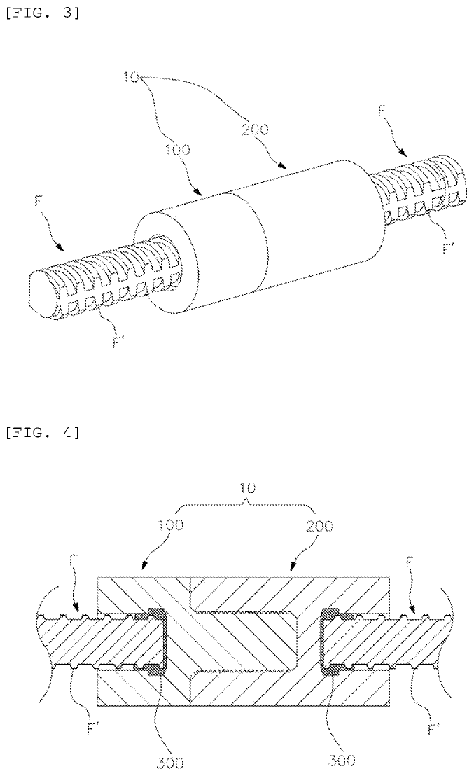

Hereinafter, the configuration of a reinforcing bar coupler 10 according to the present invention will be described with reference to the accompanying FIGS. 3 and 4.

FIG. 3 shows a perspective view showing a using example of the reinforcing bar coupler 10 according to the present invention, and FIG. 4 shows a longitudinal sectional view showing an internal structure of the reinforcing bar coupler 10 according to the present invention.

The term or word used in the specification and claims of the present invention will not be construed as a conventional and lexical meaning, and will be construed as the meanings and concepts consistent with the technical idea of the present invention based on the principle that “an inventor may define the concept of the term properly in order to describe the invention in the best way”.

Thus, the embodiments described herein and the configurations shown in the drawings are merely exemplary embodiments according to the present invention, and may not represent all of the technical ideas of the present invention. Therefore, it will be understood that various equivalents and modifications may be substituted therefor at the time of filing of the present application.

As shown in the drawings, the reinforcing bar coupler 10 according to the present invention is configured to connect a pair of reinforcing bars F on a straight line, and composed of a pair of different shapes, so as to be screwed to each other while being integrally coupled to ends of reinforcing bars F, respectively, so that the pair of reinforcing bars can be connected to each other.

In other words, the reinforcing bar coupler 10 includes a first coupler 100 and a second coupler 200, wherein a right end of the reinforcing bar F positioned on a left side is integrally inserted and coupled into a left side of the first coupler 100, and a left end of the reinforcing bar F positioned on a right side is integrally inserted and coupled into a right side of the second coupler 200, so as to be screwed together while being close to each other, so that a right side of the first coupler 100 is inserted into the second coupler 200 and restrained, thereby coupling the pair of reinforcing bars F on a straight line.

The first coupler 100 and the second coupler 200 are coupled to the ends of the reinforcing bars F and integrated with the reinforcing bars F, respectively. In the embodiment of the present invention, the first coupler 100 and the second coupler 200 are firmly integrated with the reinforcing bars F through friction welding.

In other words, the reinforcing bars F have ends melted by friction welding inside the first coupler 100 and the second coupler 200, and welded with the inside of the first coupler 100 or the second coupler 200 so as to be integrated by a welding part 300, and integrated while the slip is prevented by knurling protrusions F′ protruding from an outer surface of the reinforcing bar F.

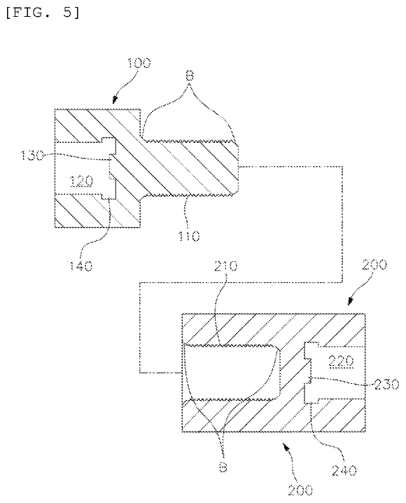

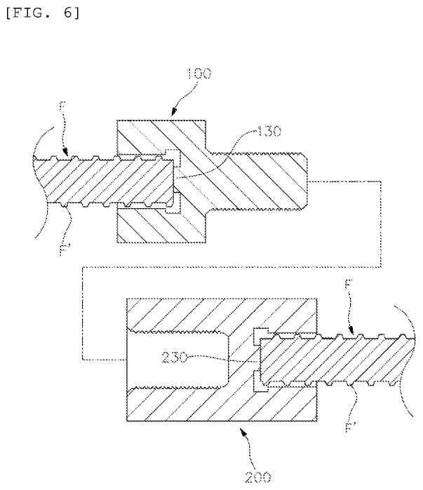

Hereinafter, the detailed configuration of the first coupler 100 and the second coupler 200 will be described with reference to the accompanying FIGS. 5 and 6.

FIG. 5 shows an exploded longitudinal sectional view illustrating a structure between the first coupler 100 and the second coupler 200, which are the main components in the reinforcing bar coupler 10 according to the present invention. FIG. 6 shows a longitudinal sectional view illustrating a state in which reinforcing bars F are inserted into the first coupler 100 and the second coupler 200, which are the main components in the reinforcing bar coupler 100 according to the present invention.

As shown in the drawings, the first coupler 100 and the second coupler 200 have adjacent portions formed differently from each other and are coupled by screw coupling.

To this end, a connecting male screw 110 is formed on the right side of the first coupler 100, and a connecting female screw 210 recessed to the right side and having an outer diameter and a pitch corresponding to the connecting male screw 110 is formed on the left side of the second coupler 200.

A multi-row screw type, such as 2 or 3 rows, may be applied to the connecting male screw 110 and the connecting female screw 210 to shorten time upon the screw coupling.

In addition, the connecting male screw 110 and the connecting female screw 210 are provided at both ends thereof with vibration-prevention parts B. The vibration-prevention parts B are configured to come into contact with each other when the connecting male screw 110 and the connecting female screw 210 are completely screwed to each other, thereby restricting the first coupler 100 and the second coupler 200 from being moved in the circumferential direction.

In other words, the connecting male screw 110 and the connecting female screw 210 have a clearance due to the connection by screw coupling. Accordingly, the connection may be released by reciprocating vibration or external shock. In order to prevent the above-described risk, the vibration-prevention parts B are provided, respectively, to prevent the first coupler 100 and the second coupler 200 from being fundamentally moved relatively to each other.

The first coupler 100 and the second coupler 200 are configured to have the same shape at opposite portions in which the connecting male screw 110 and the connecting female screw 210 are not formed, and the main components of the present invention are included at this point.

More specifically, a first accommodation space 120 and a second accommodation space 220 are formed on the left side of the first coupler 100 and the right side of the second coupler 200, respectively.

The first accommodation space 120 and the second accommodation space 220 are spaces formed by removing cylindrical shapes having the same inner diameter from the first coupler 100 and the second coupler 200, have an inner diameter greater than the outer diameter of the reinforcing bar F, and are recessed to a depth capable of accommodating at least one knurling protrusion F′ of the reinforcing bar F.

Accordingly, as shown in FIG. 6, the ends of the reinforcing bars F may be directly inserted into the first accommodation space 120 and the second accommodation space 220 without interference or rotation.

A first melting part 130 and a second melting part 230 protruding in opened directions are provided, respectively, on inner wall surfaces of the first accommodation space 120 and the second accommodation space 220.

The first melting part 130 and the second melting part 230 are designed to be melted before the reinforcing bar F during friction welding with the reinforcing bar F, and configured to have an outer diameter smaller than that of the reinforcing bar F.

In other words, it is applied by considering that a portion having a small diameter is heated and melted first due to different heat dissipation rates when one of two surfaces requiring friction welding is rotated at high speed while coming into contact with each other and frictional heat is generated.

In the embodiment of the present invention, when the reinforcing bars F are coupled to the first and second couplers 100 and 200 by friction welding, respectively, the first coupler 100 and the second coupler 200 are rotated at high speed to be integrated with the reinforcing bars F while the reinforcing bars F are fixed.

A first catching groove 140 and a second catching groove 240 are formed on outsides of the first melting part 130 and the second melting part 230. The first catching groove 140 and the second catching groove 240 are configured to have the largest inner diameter in the first accommodation space 120 and the second accommodation space 220 so as to function to accommodate molten metal formed by melting the first melting part 130, the second melting part 230 and the reinforcing bars F and catch and restrain the welding parts 300 formed by solidifying the molten metal from being drawn out in the longitudinal directions of the reinforcing bars F.

More specifically, when the first catching groove 140 and the second catching groove 240 are not formed, the binding force to the reinforcing bars F are deteriorated even when the first melting part 130 and the second melting part 230 are melted to wrap around outer sides of the reinforcing bars F, and accordingly, the reinforcing bars F may be pulled out in the longitudinal directions when tensile force is applied to the reinforcing bars F.

Thus, when the welding part 300 is formed as filling the first catching groove 140 and the second catching groove 240, the reinforcing bars F may be caught and restrained.

Hereinafter, the process of connecting a pair of reinforcing bars F on a straight line will be described with reference to the accompanying FIGS. 4 to 7.

First, as shown in FIG. 5, the first coupler 100 and the second coupler 200 are prepared, and the left side of the first coupler 100 and the right side of the second coupler 200 are coupled to the reinforcing bars F by friction welding, respectively.

In other words, as shown in FIG. 6, while the reinforcing bars F are inserted into the first accommodation space 120 and the second accommodation space 220, and the ends of the reinforcing bars F come into contact with the first melting part 130 and the second melting part 230, respectively, friction welding is performed by rotating the first coupler 100 and the second coupler 200 at a high speed.

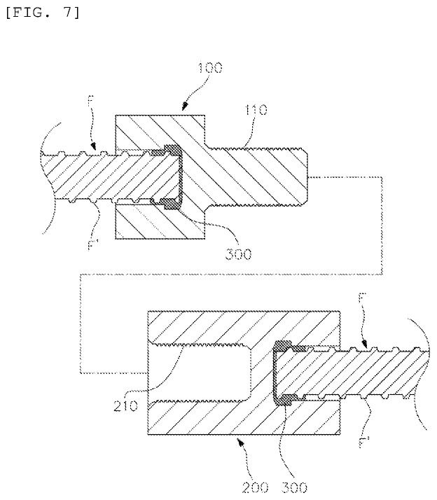

The first melting part 130 and the second melting part 230 are melted before the reinforcing bars F, and thereafter, the ends of the reinforcing bars F are also partially melted to fill the first catching groove 140 and the second catching groove 240 as shown in FIG. 7, in which molten metal remaining after filling the first catching groove 140 and the second catching groove 240 may pass over the knurling protrusions F′, thereby further increasing the binding force to the reinforcing bars F.

As in the above, when at least one of the first coupler 100 and the second coupler 200 are rotated while being close to each other in the state as shown in FIG. 7 in which the reinforcing bars F are connected to the first coupler 100 and the second coupler 200, respectively, the pair of reinforcing bars F may be placed on a straight line due to the screw coupling between the connecting male screw 110 and the connecting female screw 210 as shown FIG. 4.

The vibration-prevention parts B inclined at both ends of the connecting male screw 110 and the connecting female screw 210 are in surface contact with each other, thereby removing the clearance between the connecting male screw 110 and the connecting female screw 210, so that loosening between the first coupler 100 and the second coupler 200 due to the vibration or impact may be prevented.

The pair of reinforcing bars F are completely connected through the above-described process, and accordingly the first coupler 100 and the second coupler 200 can be transferred to construction sites in a state of being joined with the reinforcing bars F by the friction welding in advance.

The scope of the present invention is not limited to the embodiments exemplified above, and various other modifications based on the present invention will be available for those skilled in the art within the above technical scope.

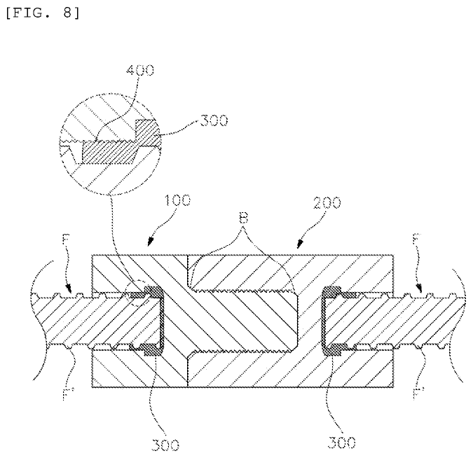

For example, in the embodiments of the present invention, the first accommodation space 120 and the second accommodation space 220 are configured to have smooth inner wall surfaces, however, a plurality of filling wedges 400 may be provided to increase the binding force on the reinforcing bars F, so that the slip can be prevented as shown in FIG. 8.

### INDUSTRIAL APPLICABILITY

The reinforcing bar coupler according to the present invention may have the industrial applicability in that a first coupler and a second coupler are joined to ends of reinforcing bars by friction welding, respectively, and the first coupler and the second coupler are connected to each other by screw-coupling, so that the connection workability may be improved, and the bending stress and the joint strength may be improved to facilitate durability against reciprocating vibration.

1. A reinforcing bar coupler comprising:
a first coupler and a second coupler integrally coupled by friction welding while accommodating end portions of a pair of reinforcing bars therein, and confined in contact with each other by screw coupling, so that the pair of reinforcing bars are connected on a straight line, wherein
each of the first coupler and the second coupler has one side including:
an accommodation space recessed to accommodate one end portion of the reinforcing bar; and
a catching groove having a largest inner diameter inside the accommodation space to accommodate molten metal formed by melting parts of the first coupler, the second coupler and the reinforcing bars, and catch and restrain solidified molten metal so that the solidified molten metal is prevented from flowing out in a longitudinal direction of the reinforcing bar.

2. The reinforcing bar coupler of claim 1, wherein the accommodation space is formed at one side inside thereof with a melting part protruding to have an outer diameter smaller than an outer diameter of the reinforcing bar and melted before the reinforcing bar during the friction welding with the reinforcing bar.

3. The reinforcing bar coupler of claim 2, wherein the first coupler and the second coupler are formed with any one of a connecting male screw and a connecting female screw screwed to each other so as to be positioned on a straight line, and have the same shape at opposite portions in which the connecting male screw and the connecting female screw are not formed.

4. The reinforcing bar coupler of claim 1, wherein the accommodation space is formed at one side inside thereof with a melting part protruding to have an outer diameter smaller than an outer diameter of the reinforcing bar and melted before the reinforcing bar during the friction welding with the reinforcing bar.

5. The reinforcing bar coupler of claim 4, wherein the accommodation space is formed on an inner circumferential surface thereof with a plurality of filling wedges for accommodating molten metal remaining after filling the catching groove to increase binding force to the reinforcing bar.
